(19) United States
(12) Patent Application Publication
(10) Pub. No.: US 2022/0254558 A1
(43) Pub. Date: Aug. 11, 2022

(54) MAGNETIC DEVICE

(71) Applicant: Delta Electronics, Inc., Taoyuan City (TW)

(72) Inventors: Huai-Pei TUNG, Taoyuan City (TW); Chun-Ching YEN, Taoyuan City (TW); Tsai-Sheng LIN, Taoyuan City (TW)

(21) Appl. No.: 17/393,974

(22) Filed: Aug. 4, 2021

(30) Foreign Application Priority Data
Feb. 9, 2021 (CN) 202110178191.0

(51) Int. Cl. H01F 27/24; H01F 27/28

(52) U.S. Cl. CPC H01F 27/24; H01F 27/28

(57) ABSTRACT

A magnetic device is provided, including an upper magnetic core, a lower magnetic core, a coil, and a permeability member, wherein the permeability member is disposed between the upper magnetic core and the lower magnetic core. The coil is enclosed by the permeability member, and the permeability member is in contact with the upper magnetic core and the lower magnetic core.

### CROSS REFERENCE TO RELATED APPLICATIONS

This application claims the benefit of China Patent Application No. 202110178191.0, filed Feb. 9, 2021, the entirety of which is incorporated by reference herein.

### BACKGROUND OF THE INVENTION

### Field of the Invention

The application relates in general to a magnetic device, and in particular, to a magnetic device having a permeability member.

### Description of the Related Art

Many electronic apparatuses include one or more components having a coil and a magnetic member, such as inductors or transformers. In order to prevent short circuits between the coil and the magnetic member, and to meet safety regulations, the coil is usually separated from the magnetic member by an air gap. However, use of this structure can increase loss, and the efficiency of the components is reduced. Therefore, how to address the aforementioned problem has become an important issue.

### BRIEF SUMMARY OF INVENTION

An embodiment of the invention provides a magnetic device, including an upper magnetic core, a lower magnetic core, a coil, and a permeability member, wherein the permeability member is disposed between the upper magnetic core and the lower magnetic core. The coil is enclosed by the permeability member, and the permeability member is in contact with the upper magnetic core and the lower magnetic core.

In some embodiments, the initial permeability of the permeability member is larger than the initial permeability of air. The initial permeability of the upper magnetic core is larger than the initial permeability of the permeability member. The initial permeability of the lower magnetic core is larger than the initial permeability of the permeability member.

In some embodiments, the permeability member is made by mixing adhesive glue and powder with high permeability.

In some embodiments, the upper magnetic core is connected to the lower magnetic core, an accommodating space is formed between the upper magnetic core and the lower magnetic core, and the permeability member is disposed in the accommodating space. The upper magnetic core comprises two lateral pillars, the accommodating space is formed between the lateral pillars, and at least a portion of the outline of each of the lateral pillars is substantially the same as at least a portion of the outline of the permeability member. In some embodiments, the accommodating space is fully filled by the permeability member.

In some embodiments, the upper magnetic core comprises a first protruding portion, the lower magnetic core comprises a second protruding portion, the first protruding portion is aligned with the second protruding portion, and the permeability member surrounds the first protruding portion and the second protruding portion. A portion of the permeability member is disposed between the coil and the first protruding portion.

In some embodiments, the coil has an annular structure, the annular structure surrounds a hollow portion, and the hollow portion is fully filled by the permeability member.

In some embodiments, the magnetic device further comprises a winding frame having a plurality of leads.

### BRIEF DESCRIPTION OF DRAWINGS

The invention can be more fully understood by reading the subsequent detailed description and examples with references made to the accompanying drawings, wherein:

FIG. 1 is a schematic diagram of a magnetic device according to an embodiment of the invention;

FIG. 2 is an exploded-view diagram of the magnetic device according to an embodiment of the invention;

FIG. 3 is a cross-sectional view along line A-A in FIG. 1;

FIG. 4 is a cross-sectional view along line B-B in FIG. 1;

FIG. 5 is a schematic diagram of a magnetic device according to another embodiment of the invention;

FIG. 6 is an exploded-view diagram of the magnetic device according to another embodiment of the invention;

FIG. 7 is a cross-sectional view along line C-C in FIG. 5; and

FIG. 8 is a schematic diagram of a magnetic device according to still another embodiment of the invention.

### DETAILED DESCRIPTION OF INVENTION

The making and using of the embodiments of the magnetic device are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The following disclosure provides many different embodiments, or examples, for implementing different features of the subject matter provided. Specific examples of solutions and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

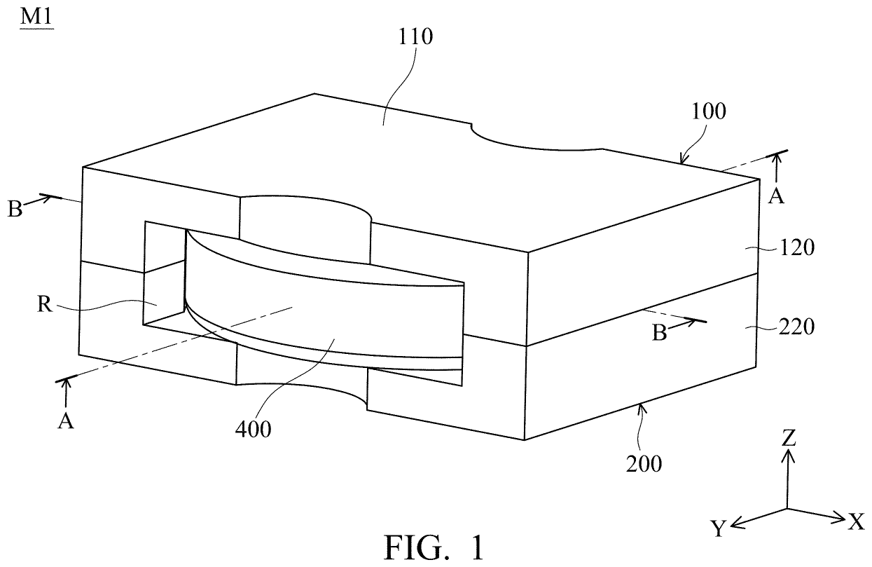

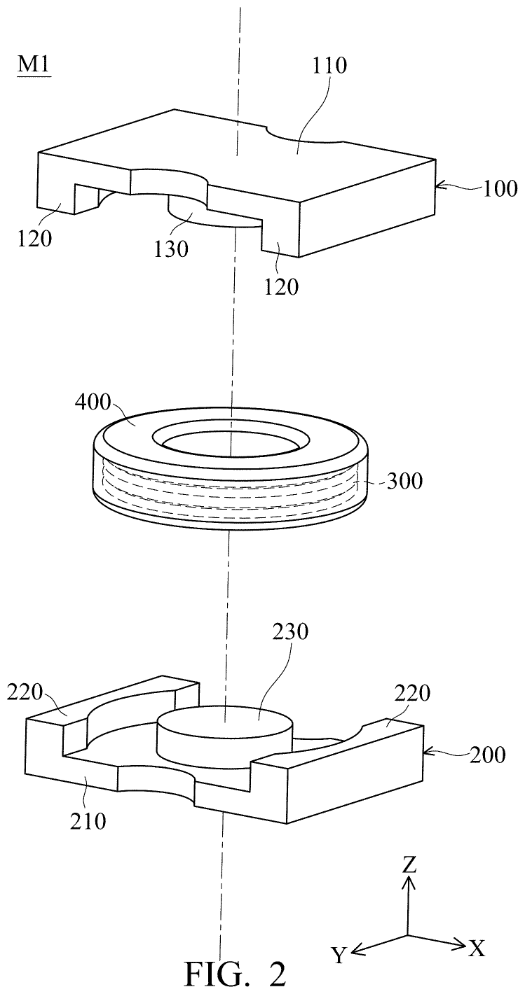

Referring to FIG. 1 and FIG. 2, in an embodiment of the invention, a magnetic device M1 primarily includes an upper magnetic core 100, a lower magnetic core 200, a coil 300, and a permeability member 400. The upper magnetic core 100 and the lower magnetic core 200 can be assembled, and an accommodating space R can be formed therebetween. In this embodiment, the magnetic device M1 can be an inductor, configured to reduce a ripple, remove noise, reduce electromagnetic interference (EMI), and/or converse power. The magnetic device M1 can be applied to many different electronic apparatuses, such as a power supply, a mother board, and a modem, but it is not limited thereto.

The upper magnetic core 100 has an E-shaped structure. In detail, the upper magnetic core 100 includes a top plate 110, two lateral pillars 120, and a first protruding portion 130. Two lateral pillars 120 are connected to the top plate 110, and respectively disposed on opposite ends of a surface of the top plate 110. The first protruding portion 130 is disposed on the center of the top plate 110, and separated from the lateral pillars 120. In this embodiment, the first protruding portion 130 has a cylindrical structure. When the upper magnetic core 100 and the lower magnetic core 200 are assembled, two lateral pillars 120 and the first protruding portion 130 are extended toward the lower magnetic core 200.

Similarly, the lower magnetic core 200 has an E-shaped structure. In detail, the lower magnetic core 200 includes a bottom plate 210, two lateral pillars 220, and a second protruding portion 230. Two lateral pillars 220 are connected to the bottom plate 210, and respectively disposed on opposite ends of the bottom plate 210. The second protruding portion 230 is disposed on the center of the bottom plate 210, and separated from the lateral pillars 220. In this embodiment, the second protruding portion 230 has a cylindrical structure. When the upper magnetic core 100 and the lower magnetic core 200 are assembled, two lateral pillars 220 and the second protruding portion 230 are extended toward the upper magnetic core 100, and the accommodating space R is formed between the lateral pillars 120 and the lateral pillars 220.

In this embodiment, the appearance and the dimensions of the cross-section of the first protruding portion 130 are substantially the same as that of the second protruding portion 230. When the upper magnetic core 100 and the lower magnetic core 200 are assembled, the first protruding portion 130 is aligned with the second protruding portion 230, so that a pillar in the accommodating space R can be formed.

It should be noted that, the upper magnetic core 100 and the lower magnetic core 200 are made of high initial permeability (μi) material, such as the material having the initial permeability ranged from 8000 to 10000. For example, the upper magnetic core 100 and the lower magnetic core 200 can include iron, manganese, zinc, amorphous metal, a combination thereof, or an alloy thereof, but it is not limited thereto. In this embodiment, the top plate 110, the lateral pillars 120, and the first protruding portion 130 of the upper magnetic core 100 are integrally formed as one piece, and the bottom plate 210, the lateral pillars 220, and the second protruding portion 230 are integrally formed as one piece.

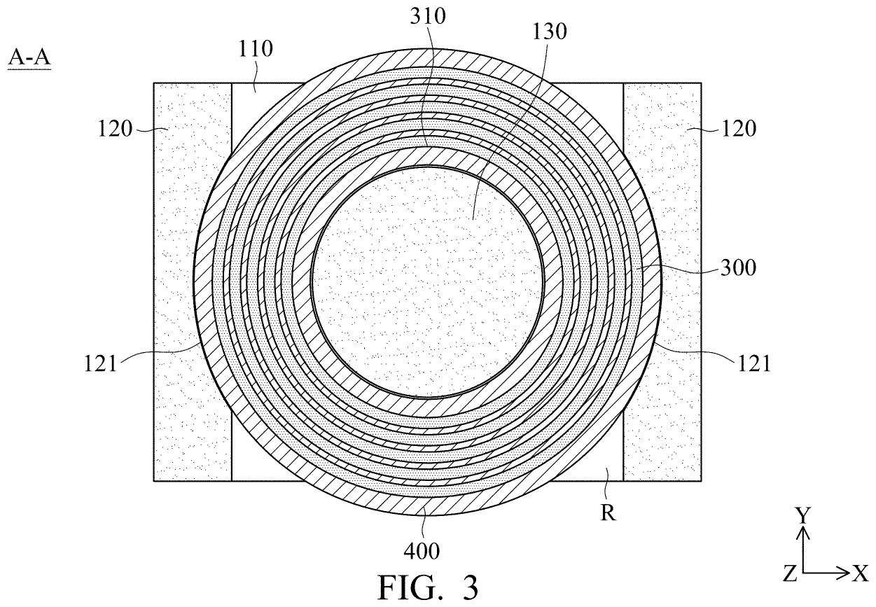

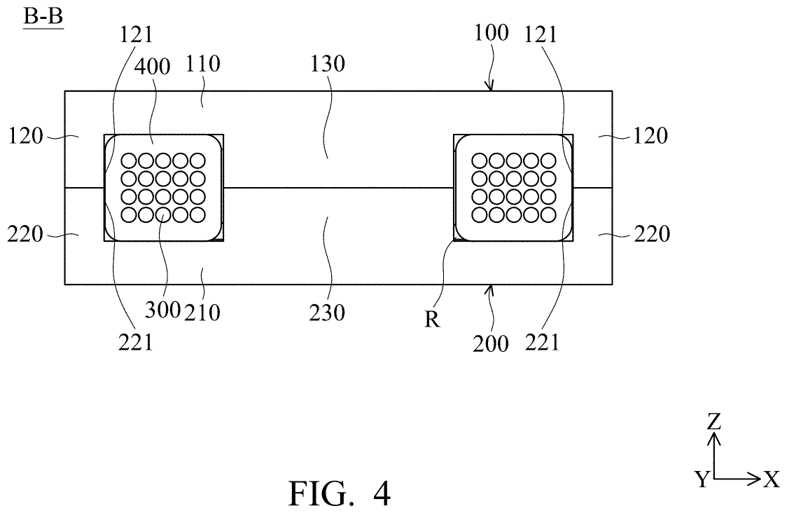

FIG. 3 is a cross-sectional view along line A-A of the aforementioned magnetic device M1, and FIG. 4 is a cross-sectional view along line B-B of the aforementioned magnetic device M1. As shown in FIG. 1 to FIG. 4, when the magnetic device M1 is assembled, the coil 300 and the permeability member 400 are accommodated in the accommodating space R, and surround the pillar formed by the first protruding portion 130 and the second protruding portion 230. The coil 300 is enclosed by the permeability member 400, and the permeability member 400 is in contact with the upper magnetic core 100 and the lower magnetic core 200.

The permeability member 400 includes powder with high permeability and adhesive glue. When the powder with high permeability and adhesive glue are mixed, they can enclose the entire coil 300 by injection molding. Subsequently, the baking temperature can be increased (for example, to 130° C.-150° C.), and the mixture of the powder and the adhesive glue can be baked and cured. The permeability member 400 enclosing the coil 300 can be therefore formed. The initial permeability of the permeability member 400 formed by the aforementioned method is larger than the initial permeability of the air (the initial permeability of the air is 1). For example, the initial permeability of the permeability member 400 is ranged from 2000 to 3000.

In this embodiment, when the permeability member 400 enclosing the coil 300 is disposed in the accommodating space R, the permeability member 400 is disposed between two lateral pillars 120 of the upper magnetic core 100. A concave surface 121 is formed on the surface of each of the lateral pillars 120 facing the permeability member 400, and the outline of the concave surface 121 corresponds to the outline of the permeability member 400. Therefore, when the permeability member 400 is disposed in the accommodating space R, the permeability member 400 can be in contact with the concave surfaces 121 of the lateral pillars 120, and positioned by the concave surfaces 121.

Similarly, when the permeability member 400 enclosing the coil 300 is disposed in the accommodating space R, the permeability member 400 is disposed between two lateral pillars 220 of the lower magnetic core 200. A concave surface 221 is formed on the surface of each of the lateral pillars 220 facing the permeability member 400, and the outline of the concave surface 221 corresponds to the outline of the permeability member 400. Therefore, when the permeability member 400 is disposed in the accommodating space R, the permeability member 400 can be in contact with the concave surfaces 221 of the lateral pillars 220, and positioned by the concave surfaces 221.

Moreover, when the upper magnetic core 100 and the lower magnetic core 200 are assembled, the distance between the top plate 110 and the bottom plate 210 is substantially the same as the thickness of the permeability member 400. Therefore, when the permeability member 400 is disposed in the accommodating space R, the permeability member 400 is in contact with the top plate 110 of the upper magnetic core 100 and the bottom plate 210 of the lower magnetic core 200.

Furthermore, the coil 300 has an annular structure. The annular structure surrounds a hollow portion 310, and the first protruding portion 130 and the second protruding portion 230 passes through the hollow portion 310. Since the coil 300 is fully enclosed by the permeability member 400, a portion of the permeability member 400 is disposed between the coil 300 and the first protruding portion 130 and/or between the coil 300 and the second protruding portion 230.

Owing to the aforementioned structure, the air gaps between the coil 300 and the upper magnetic core 100 and between the coil 300 and the lower magnetic core 200 can be reduced. Thus, the inductance can be enhanced, and the ripple on the circuit can be reduced.

In some embodiments, the accommodating space R can be fully filled by the permeability member 400, so as to increase the contact area between the permeability member 400 and the upper magnetic core 100 and the contact area between the permeability member 400 and the lower magnetic core 200. The inductance can be further enhanced, and the permeability member 400 can be steadily positioned.

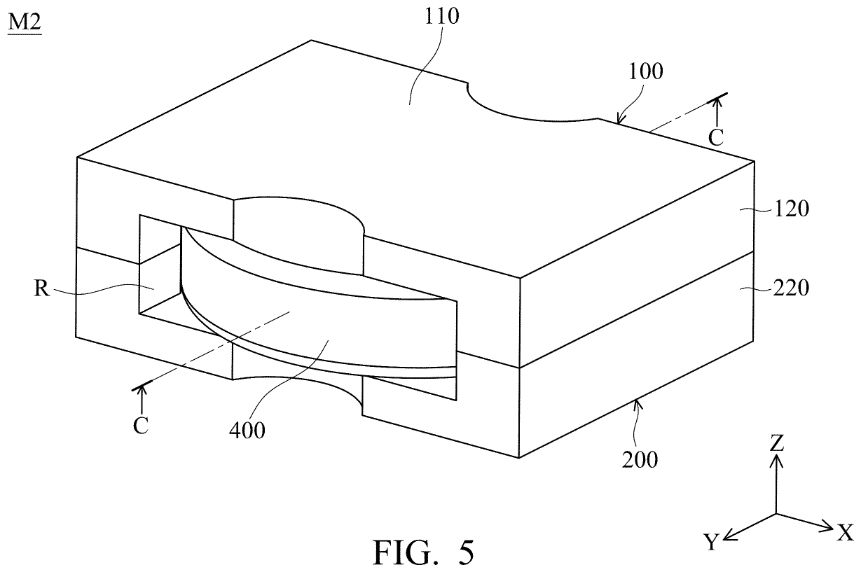

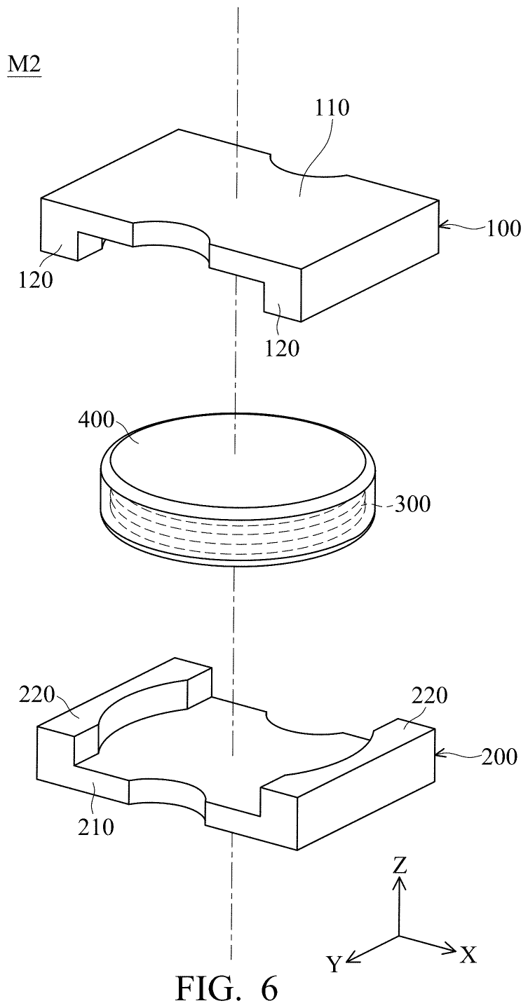

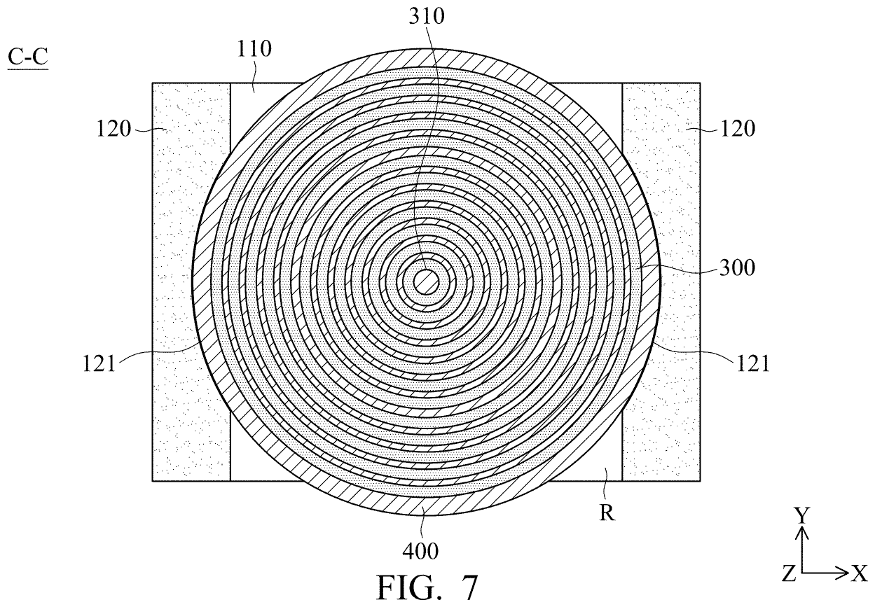

Referring to FIG. 5 to FIG. 7, in another embodiment of the invention, a magnetic device M2 primarily includes an upper magnetic core 100, a lower magnetic core 200, a coil 300, and a permeability member 400. The structures and the arrangements of the components in the magnetic device M2 are substantially the same as that of in the magnetic device M1, so that the same features thereof are not repeated in the interest of brevity.

The difference between the magnetic device M2 and the magnetic device M1 is in that, each of the upper magnetic core 100 and the lower magnetic core 200 has a C-shaped structure. Thus, the magnetic device M2 does not include the first protruding portion 130 and the second protruding portion 230, which are disposed in the accommodating space R. The coil 300 includes an annular structure and a hollow portion 310 surrounded by the annular structure, and hollow portion 310 is fully filled by the permeability member 400.

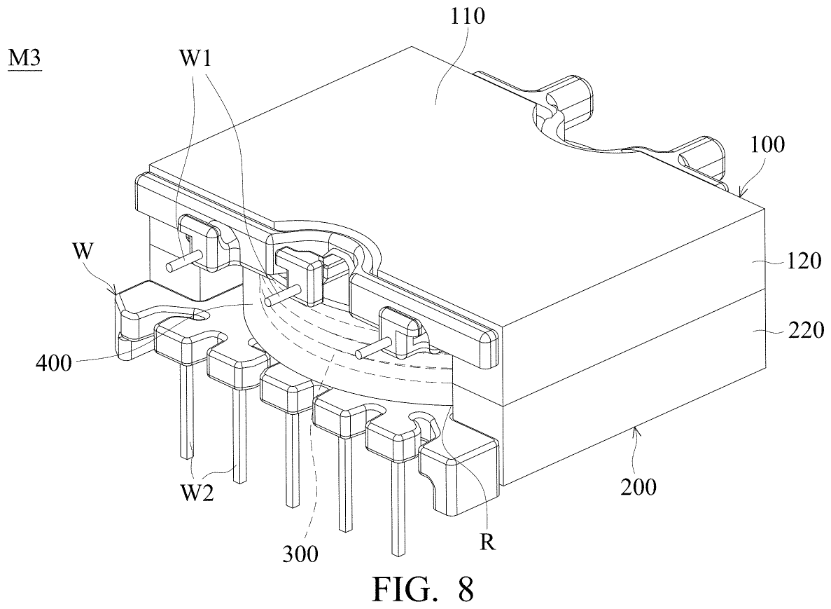

Referring to FIG. 8, in another embodiment of the invention, a magnetic device M3 primarily includes an upper magnetic core 100, a lower magnetic core 200, a coil 300, and a permeability member 400. The structures and the arrangements of the components in the magnetic device M3 are substantially the same as that of in the magnetic device M1, so that the same features thereof are not repeated in the interest of brevity. In this embodiment, the magnetic device M3 can be a transformer. When a current flows into the magnetic device M3, the magnetic device M3 can output a current with different voltage by electromagnetic induction.

The difference between the magnetic device M3 and the magnetic device M1 is in that, the magnetic device M3 further includes a winding frame W. The first protruding portion 130 of the upper magnetic core 100 and the second protruding portion 230 of the lower magnetic core 200 pass through the through hole at the center of the winding frame W, and the permeability member 400 surrounds the outer surface of the winding portion of the winding frame W. One or more leads W1 and W2 are disposed on the winding frame W, and the ends of the coil 300 disposed in the permeability member 400 can pass the permeability member 400 and wind on the leads W1 and W2.

In summary, a magnetic device is provided, including an upper magnetic core, a lower magnetic core, a coil, and a permeability member, wherein the permeability member is disposed between the upper magnetic core and the lower magnetic core. The coil is enclosed by the permeability member, and the permeability member is in contact with the upper magnetic core and the lower magnetic core. Owing to the aforementioned structure of the magnetic device, the inductance of the magnetic device can be effectively enhanced, and the ripple on the circuit can be reduced. Moreover, since there is no need to dispose other additional positioning member to position the coil, the manufactory can be simplified, and the whole size of the magnetic device can be reduced. The magnetic device can be miniaturized.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A magnetic device, comprising:
an upper magnetic core;
a lower magnetic core;
a coil; and
a permeability member, disposed between the upper magnetic core and the lower magnetic core, wherein the coil is enclosed by the permeability member, and the initial permeability of the upper magnetic core and/or the initial permeability of the lower magnetic core is larger than the initial permeability of the permeability member.

2. The magnetic device as claimed in claim 1, wherein the permeability member is in contact with the upper magnetic core and the lower magnetic core.

3. The magnetic device as claimed in claim 1, wherein the permeability member is made by mixing adhesive glue and powder with high permeability.

4. The magnetic device as claimed in claim 1, wherein the upper magnetic core is connected to the lower magnetic core, an accommodating space is formed between the upper magnetic core and the lower magnetic core, and the permeability member is disposed in the accommodating space.

5. The magnetic device as claimed in claim 4, wherein the upper magnetic core comprises two lateral pillars, the accommodating space is formed between the lateral pillars, and at least a portion of the outline of each of the lateral pillars is substantially the same as at least a portion of the outline of the permeability member.

6. The magnetic device as claimed in claim 4, wherein the accommodating space is fully filled by the permeability member.

7. The magnetic device as claimed in claim 1, wherein the upper magnetic core comprises a first protruding portion, the lower magnetic core comprises a second protruding portion, the first protruding portion is aligned with the second protruding portion, and the permeability member surrounds the first protruding portion and the second protruding portion.

8. The magnetic device as claimed in claim 7, wherein a portion of the permeability member is disposed between the coil and the first protruding portion.

9. The magnetic device as claimed in claim 1, wherein the coil has an annular structure, the annular structure surrounds a hollow portion, and the hollow portion is fully filled by the permeability member.

10. The magnetic device as claimed in claim 1, wherein the coil has an annular structure, the annular structure surrounds a hollow portion, the upper magnetic core comprises a first protruding portion, the lower magnetic core comprises a second protruding portion, the first protruding portion and the second protruding portion pass through the hollow portion.

11. The magnetic device as claimed in claim 1, wherein the magnetic device further comprises a winding frame having a plurality of leads, the winding frame is disposed between the upper magnetic core and the lower magnetic core, and the permeability member surrounds the winding frame.
